(19) United States
(12) Patent Application Publication
(10) Pub. No.: US 2020/0189981 A1
(43) Pub. Date: Jun. 18, 2020

(54) METHOD OF MANUFACTURING REFRACTORY

(71) Applicants: Koyo Thermo Systems Co., Ltd., Nara (JP); ROZAI KOGYO KAISHA, LTD., Osaka (JP)

(72) Inventors: Amane MATSUBARA, Tenri-shi (JP); Yasuhiro MORIMOTO, Tenri-shi (JP); Michio ISHIZUKA, Ako-shi (JP); Naoyuki NARUSE, Ako-shi (JP)

(73) Assignees: Koyo Thermo Systems Co., Ltd., Nara (JP); ROZAI KOGYO KAISHA, LTD., Osaka (JP)

(21) Appl. No.: 16/710,890

(22) Filed: Dec. 11, 2019

(30) Foreign Application Priority Data
Dec. 12, 2018 (JP) 2018-232924

(51) Int. Cl. C04B 35/626; C04B 35/117

(52) U.S. Cl. CPC C04B 35/62675; C04B 35/117; C04B 2235/6567; C04B 2235/3418; C04B 2235/3272; C04B 2235/3217

(57) ABSTRACT

In a firing condition determination step S101a, as firing conditions for firing a refractory, an Fe₂O₃ amount (mass %) which is an Fe₂O₃ content, a target firing temperature T (° C.) to which the temperature of the refractory is raised when the refractory is fired and a continuous firing time t (hr) during which the firing is continued at the target firing temperature T are determined. The Fe₂O₃ amount, the target firing temperature T and the continuous firing time t are determined so as to satisfy all five formulas of 1.2<Fe₂O₃ amount ≤2.5, 1250≤T≤1450, 0≤t, P=0.0101×T+0.0913×t−12.3 and P>0.992×Fe₂O₃ amount+0.080.

### CROSS-REFERENCE TO RELATED APPLICATION

This application claims priority to Japanese Patent Application No. 2018-232924. The entire disclosure of Japanese Patent Application No. 2018-232924 is hereby incorporated herein by reference.

### TECHNICAL FIELD

The present invention relates to a method of manufacturing an Al₂O₃—SiO₂-based refractory in which an Al₂O₃ content is equal to or more than 35% and equal to or less than 80% by mass %.

### BACKGROUND ART

In a heat treatment furnace for performing heat treatment such as quenching or treatment including carburizing and quenching, a refractory is used as a material which is used as a constituent material of a furnace lining, etc., and which can withstand a high temperature within the furnace. As the heat treatment furnace refractory as described above, an Al₂O₃—SiO₂-based refractory is often used in which Al₂O₃ and SiO₂ are main components and in which an Al₂O₃ content is equal to or more than 35% and equal to or less than 80% by mass %.

The Al₂O₃—SiO₂-based refractory is manufactured by mixing and kneading Al₂O₃—SiO₂-based refractory raw materials, then molding them and further firing them. However, in the Al₂O₃—SiO₂-based refractory raw materials, as an impurity, Fe₂O₃ is normally mixed. Hence, in the refractory manufactured by using the refractory raw materials as well, Fe₂O₃ is contained. In the refractory manufactured by using the refractory raw materials in which an Fe₂O₃ content (mass %) is high, a large amount of Fe₂O₃ is contained.

When in the heat treatment furnace for which the refractory is used as the constituent material, the heat treatment such as quenching or treatment including carburizing and quenching is performed, as an atmospheric gas within the furnace during the heat treatment, an atmospheric gas is used which contains a gas such as carbon monoxide including a carbon component. When the heat treatment is performed with the heat treatment furnace in which the refractory containing a large amount of Fe₂O₃ is used as the constituent material, carbon deposits easily occur in which carbon in the atmospheric gas is deposited in the refractory. When carbon deposits occur, and thus the amount of carbon deposited in the refractory is increased, it is impossible to maintain the shape of the refractory serving as the constituent material of the furnace, with the result that the refractory collapses. Hence, in order to prevent the collapse of the refractory of the heat treatment furnace, it is necessary to use the refractory in which an Fe₂O₃ content is extremely low. Therefore, in manufacturing the heat treatment furnace refractory, in order to manufacture the refractory in which an Fe₂O₃ content is extremely low, the refractory raw materials in which an Fe₂O₃ content is extremely low are used to manufacture the refractory.

On the other hand, as a method of suppressing, in the heat treatment furnace, the occurrence of carbon deposits in which carbon in the atmospheric gas is deposited in the refractory of the heat treatment furnace without use of the refractory in which an Fe₂O₃ content is low, a method disclosed in Patent Document 1 is known. In the method disclosed in Patent Document 1, as a constituent material of the heat treatment furnace, a material is used in which a thermal spray coating layer is formed by thermally spraying a material such as alumina or zirconia on the surface of the refractory. In this way, the refractory is blocked from the atmospheric gas, and thus the occurrence of carbon deposits is suppressed.

### CITATION LIST

### Patent Document

Patent Document 1: Japanese Published Unexamined Patent Application No. S57-100988

### SUMMARY OF THE INVENTION

As described above, in terms of suppressing the occurrence of carbon deposits in which carbon is deposited in the refractory of the heat treatment furnace during the heat treatment to prevent the collapse of the refractory, as the heat treatment furnace refractory, the refractory is used in which an Fe₂O₃ content is extremely low. In manufacturing the heat treatment furnace refractory, in order to manufacture the refractory in which an Fe₂O₃ content is extremely low, the refractory raw materials in which an Fe₂O₃ content is extremely low are used to manufacture the refractory. However, in general Al₂O₃—SiO₂-based refractory raw materials, as an impurity, Fe₂O₃ is normally mixed. Hence, in order to manufacture the refractory in which an Fe₂O₃ content is low, it is necessary to perform treatment for reducing an Fe₂O₃ content on the refractory in which an Fe₂O₃ content is high to manufacture the refractory in which an Fe₂O₃ content is extremely low. For example, it is necessary to perform treatment for adding, as an additive material, a large amount of refractory raw material in which an Fe₂O₃ content is low to refractory raw materials in which an Fe₂O₃ content is high to reduce the Fe₂O₃ content in the refractory raw materials. In this case, it is necessary to use a large amount of an additive material for the reduction treatment of the Fe₂O₃ content, and furthermore, steps for the reduction treatment of the Fe₂O₃ content are increased, with the result that the cost of manufacturing the refractory is increased.

As disclosed in Patent Document 1, as the constituent material of the heat treatment furnace, the material is used in which the thermal spray coating layer is formed by thermally spraying the material such as alumina or zirconia on the surface of the refractory, and thus the refractory is blocked from the atmospheric gas, with the result that it is possible to suppress the occurrence of carbon deposits. However, in the method disclosed in Patent Document 1, it is necessary to perform the coating treatment in which the material such as alumina or zirconia is thermally sprayed on the surface of the refractory to form the thermal spray coating layer. When the coating treatment is performed on the surface of the refractory, it is recommended to perform thermal spraying after the furnace is installed in order to increase efficiency, and a coating operation is performed in a place such as the interior of the furnace where it is difficult to perform the operation, with the result that the cost of using the refractory as the constituent material of the heat treatment furnace is increased.

As described above, when it is attempted to suppress the occurrence of carbon deposits in the use of the refractory as the heat treatment furnace refractory, the cost of manufacturing the refractory or the cost of using the refractory as the constituent material of the heat treatment furnace is increased. That is, it is necessary to use the refractory raw materials in which an Fe₂O₃ content is extremely low to manufacture the refractory or it is necessary to perform the coating treatment on the surface of the refractory, with the result that the cost is increased. Hence, in order to realize a method of manufacturing the refractory which is capable of manufacturing a refractory for which it is possible to suppress the occurrence of carbon deposits in the use of the refractory as the heat treatment furnace refractory, it is preferable to be able to use refractory raw materials that are inexpensive in which an Fe₂O₃ content is high to remove the need for coating treatment on the surface of the refractory.

In view of the foregoing conditions, an object of the present invention is to provide a method of manufacturing the refractory which is capable of manufacturing a refractory for which it is possible to use refractory raw materials that are inexpensive in which an Fe₂O₃ content is high to remove the need for coating treatment on the surface of the refractory to suppress the occurrence of carbon deposits in the use of the refractory as a heat treatment furnace refractory.

In order to provide a method of manufacturing the refractory which is capable of manufacturing a refractory for which it is possible to suppress the occurrence of carbon deposits in the use of the refractory as a heat treatment furnace refractory, the inventor of the present application has conducted various examinations and experiments and conducted thorough research to obtain findings described in (a) to (d) below. Based on the findings, the inventor of the present application found that it is possible to manufacture the refractory for which it is possible to remove the need for coating treatment on the surface of the refractory and suppress the occurrence of carbon deposits in the use of the refractory as a heat treatment furnace refractory even when refractory raw materials that are inexpensive in which an Fe₂O₃ content is high are used by determining an Fe₂O₃ content and the firing conditions of the refractory so as to satisfy a specific relationship between the Fe₂O₃ content in the refractory and the firing conditions of the refractory, thereby the inventor completed the present invention.

(a) Conventionally, in terms of suppressing the occurrence of carbon deposits in which carbon is deposited in the refractory of a heat treatment furnace during heat treatment to prevent the collapse of the refractory, as a heat treatment furnace refractory, a refractory is used in which an Fe₂O₃ content is extremely low. On the other hand, conventionally, a relationship between the collapse of a refractory and an Fe₂O₃ content has not been clear. Hence, with respect to the firing conditions of a refractory, the inventor of the present application set conditions other than an Fe₂O₃ content to the same conditions as in a conventional method of manufacturing a heat treatment furnace refractory, variously changed the Fe₂O₃ content and fired the refractory to manufacture the refractory. Then, the inventor of the present application conducted thorough research on the relationship with the collapse of the refractory when heat treatment is performed in a heat treatment furnace using the manufactured refractory. Consequently, it has been found that in the method of manufacturing the refractory according to conventional firing conditions, when the Fe₂O₃ content is equal to or less than 1.2%, the collapse of the refractory caused by the occurrence of carbon deposits does not occur whereas when the Fe₂O₃ content exceeds 1.2%, the collapse of the refractory caused by the occurrence of carbon deposits occurs. Hence, it has been found that it is preferable to be able to suppress the occurrence of carbon deposits in a heat treatment furnace using a refractory that is manufactured with refractory raw materials in which an Fe₂O₃ content exceeds 1.2%. On the other hand, an Fe₂O₃ content in a general refractory in which the reduction treatment of the Fe₂O₃ content is not performed is equal to or more than 2.0% and equal to or less than 2.2%, and the maximum is 2.5%. Hence, it has been found that if it is possible to suppress the occurrence of carbon deposits in a heat treatment furnace using a refractory in which an Fe₂O₃ content is more than 1.2% and equal to or less than 2.5%, it is possible to use refractory raw materials that are inexpensive which could not be conventionally used, in which an Fe₂O₃ content is high.

(b) The inventor of the present application has further conducted thorough research on the cause of the occurrence of carbon deposits when an Fe₂O₃ content exceeds 1.2%. Consequently, it has been found that when heat treatment is performed with a heat treatment furnace using a refractory in which an Fe₂O₃ content exceeds 1.2%, an iron oxide component in the refractory is reduced, the iron component acts as a catalyst and thus carbon deposits in which carbon in an atmospheric gas is deposited in the refractory easily occur. It has further been found that when firing is performed under the conventional firing conditions described above by using the refractory in which an Fe₂O₃ content exceeds 1.2%, carbon deposits occur, the amount of carbon deposited and contained in the refractory is increased to 0.05% by mass % and when the amount of carbon in the refractory is equal to or more than 0.05%, it is impossible to maintain the shape of the refractory serving as the constituent material of the furnace and thus the collapse of the refractory occurs.

(c) The inventor of the present application has conducted, based on the findings described above, examinations and experiments and conducted thorough research on firing conditions where even when the refractory in which an Fe₂O₃ content exceeds 1.2% is used, it is possible to fire and generate the refractory in which the amount of carbon deposited in the refractory during the heat treatment is less than 0.05%. In order to fire a refractory, it is necessary to raise the temperature of the refractory to 1250° C. which is a temperature capable of performing at least firing. On the other hand, when the temperature of the refractory is raised beyond 1450° C., the refractory is softened during firing, and thus it is impossible to maintain the shape. Hence, in the firing conditions described above, a target firing temperature that is a target temperature to which the temperature of the refractory is raised when the refractory is fired needs to be equal to or more than 1250° C. and equal to or less than 1450° C., and the research has been conducted with consideration given to this target firing temperature.

(d) As described above, the inventor of the present application has conducted thorough research on the firing conditions where even when the refractory in which an Fe₂O₃ content exceeds 1.2% is used on condition that the target firing temperature falls in a range equal to or more than 1250° C. and equal to or less than 1450° C., it is possible to fire and generate the refractory in which the amount of carbon deposited in the refractory during the heat treatment is less than 0.05%. Consequently, it has been found that as the target firing temperature is increased in the temperature range described above, the amount of iron oxide component alone left in the refractory after being fired is decreased, and that Fe₂O₃ reacts with Al₂O₃ and SiO₂ to be inactivated. It has further been found that after the temperature of the refractory is raised to the target firing temperature, the longer the continuation of the firing of the refractory at the temperature, the higher the proportion the contribution to the inactivation of Fe₂O₃ by sufficiently reacting with Al₂O₃ and SiO₂. It has then been found that it is possible to quantify, in relationship to an Fe₂O₃ content, the firing conditions of the refractory in which the amount of carbon deposited in the refractory during the heat treatment can be less than 0.050. It has further been found that even when in the refractory, an Fe₂O₃ content significantly exceeds 1.2% and is further increased in a range equal to or less than 2.50, coating treatment on the surface of the refractory is not needed, and that it is possible to quantify, in relationship to the Fe₂O₃ content, the firing conditions in which the amount of carbon deposited in the refractory during the heat treatment can be less than 0.050. Specifically, it has been found that when an Fe₂O₃ content in the refractory is assumed to be an Fe₂O₃ amount (mass %), the target firing temperature to which the temperature of the refractory is raised at the time of firing of the refractory is assumed to be T (° C.) and a continuous firing time during which the firing of the refractory is continued at the target firing temperature T after the temperature rise is assumed to be t (hr), the Fe₂O₃ amount, the target firing temperature T and the continuous firing time t are determined so as to satisfy Formulas (A) and (B) described below, the firing is performed and thus it is possible to fire and generate the refractory in which the amount of carbon deposited in the refractory during the heat treatment is less than 0.05%.

P=0.0101×T+0.0913×t−12.3 Formula (A)

P>0.992×Fe₂O₃ amount+0.080 Formula (B)

A firing parameter P calculated in Formula (A) described above is a parameter on firing conditions which is identified by a relationship between the target firing temperature T and the continuous firing time t in order to quantify a relationship between the firing conditions of the target firing temperature T and the continuous firing time t and the Fe₂O₃ amount. The Fe₂O₃ amount, the target firing temperature T and the continuous firing time t are determined such that the firing parameter P determined from the target firing temperature T and the continuous firing time t and the Fe₂O₃ amount satisfy Formula (B) described above.

The present invention is based on the findings described above, and its outline configuration is provided by methods of manufacturing a refractory [1] to [3] described below.

[1] A method of manufacturing an Al₂O₃—SiO₂-based refractory in which an Al₂O₃ content is equal to or more than 35% and equal to or less than 80% by mass % is provided, the method includes: a firing condition determination step of determining, as firing conditions for firing the Al₂O₃—SiO₂-based refractory, an Fe₂O₃ amount (mass %) which is an Fe₂O₃ content in the refractory, a target firing temperature T (° C.) serving as a target temperature to which a temperature of the refractory is raised when the refractory is fired and a continuous firing time t (hr) serving as a time during which the firing of the refractory is continued at the target firing temperature T after the temperature of the refractory is raised to the target firing temperature T; a temperature rise firing step of using the refractory which contains the Fe₂O₃ amount of Fe₂O₃ determined in the firing condition determination step and firing the refractory while raising the temperature of the refractory to the target firing temperature T; and a continuous firing step of firing the refractory whose temperature is raised to the target firing temperature T at the target firing temperature T for the continuous firing time t and in the firing condition determination step, the Fe₂O₃ amount, the target firing temperature T and the continuous firing time t are determined so as to satisfy all Formulas (1) to (5) described below.

1.2<Fe₂O₃ amount≤2.5 Formula (1)

1250≤T≤1450 Formula (2)

0≤t Formula (3)

P=0.0101×T+0.0913×t−12.3 Formula (4)

P>0.992×Fe₂O₃ amount+0.080 Formula (5)

In the configuration described above, even when refractory raw materials that are inexpensive are used which could not be conventionally used, in which an Fe₂O₃ content is high, it is possible to manufacture the refractory for which it is possible to suppress the occurrence of carbon deposits in the use of the refractory as a heat treatment furnace refractory. Then, in the refractory manufactured by the configuration described above, the amount of carbon deposited in the refractory during heat treatment in the use of the refractory as the heat treatment furnace refractory can be less than 0.05%, with the result that it is possible to prevent the collapse of the refractory. In the configuration described above, refractory raw materials that are inexpensive can be used in which an Fe₂O₃ content is high, and thus it is possible to significantly reduce the manufacturing cost. Furthermore, in the configuration described above, even when refractory raw materials that are inexpensive are used in which an Fe₂O₃ content is high, it is possible to manufacture the refractory for which it is possible to suppress the occurrence of carbon deposits, with the result that it is not necessary to perform coating treatment on the surface of the refractory. Hence, refractory raw materials that are inexpensive can be used in which an Fe₂O₃ content is high, and a treatment material and a treatment step for the coating treatment on the surface of the refractory are not needed, with the result that it is possible to significantly reduce the cost.

Hence, in the configuration described above, it is possible to provide the method of manufacturing the refractory which is capable of manufacturing a refractory for which refractory raw materials that are inexpensive can be used in which an Fe₂O₃ content is high, for which it is not necessary to perform the coating treatment on the surface of the refractory and for which the occurrence of carbon deposits in the use of the refractory as the heat treatment furnace refractory can be suppressed.

[2] In the method of manufacturing the refractory, in the firing condition determination step, the Fe₂O₃ amount is determined so as to satisfy Formula (1) described above, and then the target firing temperature T and the continuous firing time t are determined so as to satisfy Formulas (2) to (5) described above.

In the configuration described above, in the firing condition determination step, the Fe₂O₃ amount is first determined, and the target firing temperature T and the continuous firing time t are determined according to the determined Fe₂O₃ amount. Hence, as the firing conditions for firing the refractory, the use of refractory raw materials that are less expensive in which an Fe₂O₃ content is high can be preferentially determined, and thus it is possible to more significantly reduce the manufacturing cost of the refractory.

[3] In the method of manufacturing the refractory, in the firing condition determination step, the Fe₂O₃ amount is determined to be equal to or more than 2.0% and equal to or less than 2.2%, and then the target firing temperature T and the continuous firing time t are determined so as to satisfy Formulas (2) to (5) described above.

In the configuration described above, general refractory raw materials in which the reduction treatment of the Fe₂O₃ content is not performed can be used, and the reduction treatment of the Fe₂O₃ content is not needed at all, with the result that it is possible to more significantly reduce the manufacturing cost of the refractory.

The above-described and other objects, features, and advantages in the present invention will be clarified by reading the description given below along with the accompanying drawings.

### BRIEF DESCRIPTION OF THE DRAWINGS

FIG. 1 is a flowchart for illustrating an example of a method of manufacturing a refractory according to an embodiment of the present invention.

FIG. 2 is a diagram for illustrating firing conditions determined in a firing condition determination step in the method of manufacturing the refractory according to the embodiment of the present invention.

FIG. 3 is a diagram for illustrating a method of a refractory heat treatment test in which the occurrence of collapse of refractories was investigated by performing a simulation under conditions obtained by accelerating treatment conditions in a heat treatment furnace.

FIG. 4 is a graph showing a relationship between Fe₂O₃ amounts in refractories and the breakage rates of the refractories after the refractory heat treatment test.

FIG. 5 is a graph showing a relationship between the Fe₂O₃ amounts in the refractories and the deposited carbon amounts of the refractories after the refractory heat treatment test.

FIG. 6 is a graph showing a relationship between the deposited carbon amounts and the breakage rates of the refractories after the refractory heat treatment test.

FIG. 7 is a graph showing a relationship between firing parameters P and the limits of the Fe₂O₃ amounts capable of preventing the collapse of the refractories.

### EMBODIMENTS OF THE INVENTION

Hereinafter, an embodiment of the present invention will be described with reference to the drawings.

[Method of Manufacturing Refractory]

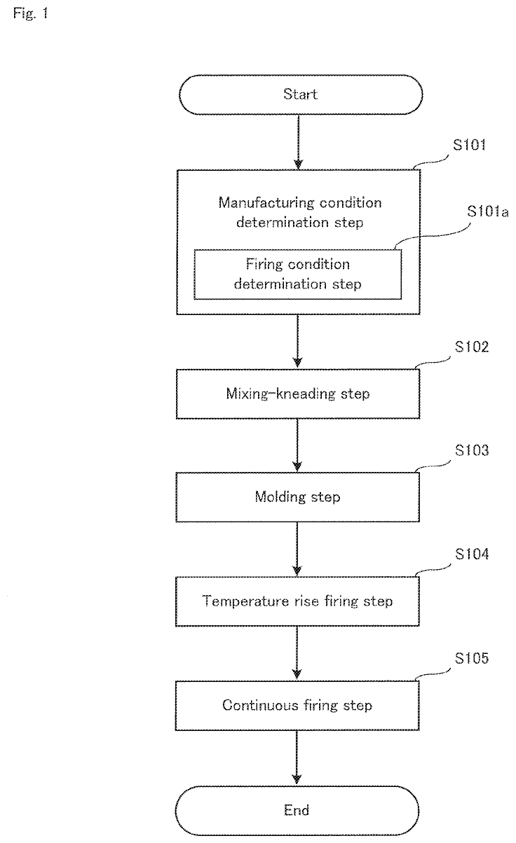

FIG. 1 is a flowchart for illustrating an example of a method of manufacturing a refractory according to the embodiment of the present invention. The method of manufacturing the refractory according to the embodiment of the present invention (hereinafter, also simply referred to as the refractory manufacturing method of the present embodiment) is a method of manufacturing a heat treatment furnace refractory which is used as a constituent material of a furnace in a heat treatment furnace for performing heat treatment such as quenching or treatment including carburizing and quenching. The refractory manufacturing method of the present embodiment is configured as a method of manufacturing an Al₂O₃—SiO₂-based refractory in which an Al₂O₃ content is equal to or more than 35% and equal to or less than 80% by mass %. The heat treatment furnace refractory is configured as the Al₂O₃—SiO₂-based refractory in which Al₂O₃ and SiO₂ are main components. In the heat treatment furnace refractory, in order to acquire fire resistance when the heat treatment furnace refractory is used as the constituent material of the heat treatment furnace, an Al₂O₃ content needs to be equal to or more than 35% by mass %.

With reference to FIG. 1, the refractory manufacturing method of the present embodiment includes a manufacturing condition determination step S101, a mixing-kneading step S102, a molding step S103, a temperature rise firing step S104 and a continuous firing step S105. In the refractory manufacturing method of the present embodiment, the individual steps S101 to S105 are performed to manufacture, as a refractory, a shaped refractory such as a firebrick. A refractory manufacturing method which does not include, among the above-described steps S101 to S105, the molding step S103 and the subsequent steps and which are formed with the manufacturing condition determination step S101 and the mixing-kneading step S102 can also be performed. In this case, it is possible to manufacture an unshaped refractory as a refractory.

(Manufacturing Condition Determination Step)

The manufacturing condition determination step S101 in the refractory manufacturing method of the present embodiment is a step of determining manufacturing conditions for manufacturing the Al₂O₃—SiO₂-based refractory. More specifically, the manufacturing condition determination step S101 is a step of determining manufacturing conditions in the individual steps of the selection of refractory raw materials, the mixing-kneading step S102, the molding step S103, the temperature rise firing step S104 and the continuous firing step S105. The manufacturing condition determination step S101 includes a firing condition determination step S101a as a step of determining firing conditions for firing the Al₂O₃—SiO₂-based refractory. In the firing condition determination step S101a of the manufacturing condition determination step S101, as the firing conditions for firing the refractory, three firing conditions of an Fe₂O₃ amount (mass %), a target firing temperature T (° C.) and a continuous firing time t (hr) are determined.

The Fe₂O₃ amount determined as the firing condition in the firing condition determination step S101a is an Fe₂O₃ content by mass % in the Al₂O₃—SiO₂-based refractory in which an Al₂O₃ content is equal to or more than 35% and equal to or less than 80% by mass %. In the firing condition determination step S101a, the Fe₂O₃ amount in the refractory is set in a range satisfying Formula (1) described below. Then, the Fe₂O₃ amount in the refractory is determined as a final value in a range satisfying Formula (1) described below and relational formulas (Formulas (4) and (5) which will be described later) which identify a relationship between the Fe₂O₃ amount in the refractory and the other firing conditions. That is, the Fe₂O₃ amount in the refractory raw material is determined as a value (Fe₂O₃ content) in a range more than 1.2% and equal to or less than 2.5% in a range satisfying Formulas (4) and (5) which will be described later.

1.2<Fe₂O₃ amount≤2.5 Formula (1)

In a case where a refractory manufactured by a conventional method of manufacturing a refractory is used in a heat treatment furnace, when an Fe₂O₃ amount in the refractory is more than 1.2%, carbon deposits in which carbon is deposited in the refractory of the heat treatment furnace during heat treatment occur, with the result that the refractory collapses. Hence, in order to use refractory raw materials that are inexpensive which could not be conventionally used, in which an Fe₂O₃ content is high, it is necessary to use refractory raw materials in which an Fe₂O₃ amount is more than 1.2%. A Fe₂O₃ content in general refractory raw materials in which the reduction treatment of the Fe₂O₃ content is not performed is 2.5% at a maximum. Hence, the upper limit of the Fe₂O₃ amount needs to be 2.5%.

The target firing temperature T determined as the firing condition in the firing condition determination step S101a is a target temperature (° C.) to which the temperature of the refractory is raised when the refractory is fired. In the firing condition determination step S101a, the target firing temperature T is set in a range satisfying Formula (2) described below. Then, the target firing temperature T is determined as a final value in a range satisfying satisfy Formula (2) described below and Formulas (4) and (5) which will be described later. That is, the target firing temperature T is determined in a range (temperatures) equal to or more than 1250° C. and equal to or less than 1450° C. in a range satisfying Formulas (4) and (5) which will be described later.

1250≤T≤1450 Formula (2)

In order to fire the refractory, it is necessary to raise the temperature of the refractory to at least 1250° C. at which the firing can be performed. On the other hand, when the temperature of the refractory is raised beyond 1450° C., the refractory is softened during firing, and thus it is impossible to maintain the shape. Hence, the target firing temperature T needs to fall in a range equal to or more than 1250° C. and equal to or less than 1450° C.

The continuous firing time t determined as the firing condition in the firing condition determination step S101a is a time (hr) during which the firing of the refractory is continued at the target firing temperature T after the temperature of the refractory is raised to the target firing temperature T. In the firing condition determination step S101a, the continuous firing time t is set in a range satisfying Formula (3) described below. Then, the continuous firing time t is determined as a final value in a range satisfying Formula (3) described below and Formulas (4) and (5) which will be described later. That is, the continuous firing time t is determined as a value (time) equal to or more than 0 hours in a range satisfying Formulas (4) and (5) which will be described later.

0≤t Formula (3)

The continuous firing time t may be 0 hours if the relational formulas to be described later which identify a relationship with the other firing conditions are satisfied. Even if the continuous firing time t is 0 hours, the firing of the refractory sufficiently proceeds while the temperature of the refractory is raised to the target firing temperature T. Hence, the firing condition of the continuous firing time t can be set equal to or more than 0 hours. When the continuous firing time t is determined to be 0 hours, and the firing of the refractory is performed, the temperature rise firing step S104 is performed in which the firing is performed while the temperature of the refractory is being raised to the target firing temperature T. However, the time during which the firing of the refractory is continued at the target firing temperature T after the completion of the temperature rise firing step S104 becomes 0 hours.

In the firing condition determination step S101a, the firing conditions are determined so as to satisfy not only Formulas (1) to (3) described above but also Formulas (4) and (5) described below. That is, in the firing condition determination step S101a, the Fe₂O₃ amount in the refractory, the target firing temperature T and the continuous firing time t are determined so as to satisfy all Formulas (1) to (3) described above and Formulas (4) and (5) described below.

P=0.0101×T+0.0913×t−12.3 Formula (4)

P>0.992×Fe₂O₃ amount+0.080 Formula (5)

In Formula (4) described above, “T” represents the target firing temperature T, and “t” represents the continuous firing time t.

A firing parameter P calculated in Formula (4) described above is a parameter on the firing conditions which is identified by a relationship between the target firing temperature T and the continuous firing time t in order to quantify a relationship between the firing conditions of the target firing temperature T and the continuous firing time t and the Fe₂O₃ amount in the refractory. In the firing condition determination step S101a, the Fe₂O₃ amount, the target firing temperature T and the continuous firing time t are determined such that Formulas (1) to (3) described above are satisfied and that moreover, the firing parameter P determined from the target firing temperature T and the continuous firing time t and the Fe₂O₃ amount satisfy Formula (5) described above.

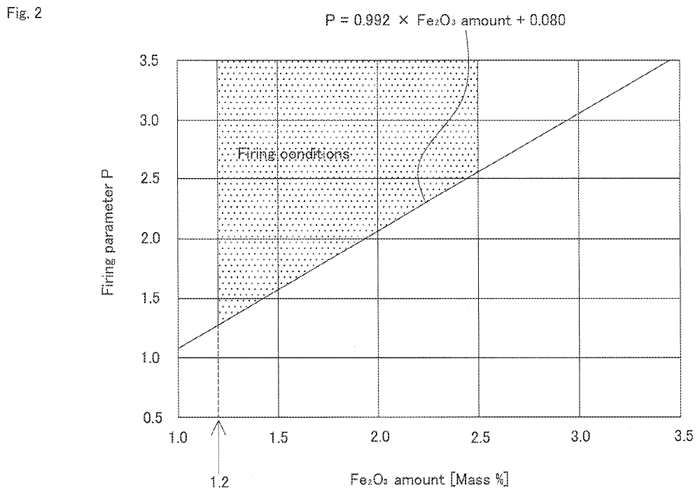

FIG. 2 is a diagram for illustrating the firing conditions determined in the firing condition determination step S101a. In FIG. 2, the firing conditions determined in the firing condition determination step S101a are indicated by a relationship between the firing parameter P and the Fe₂O₃ amount in the refractory. In the firing condition determination step S101a, as described above, the Fe₂O₃ amount, the target firing temperature T and the continuous firing time t are determined so as to satisfy all Formulas (1) to (5) described above. Hence, the firing conditions of the Fe₂O₃ amount, the target firing temperature T and the continuous firing time t are determined so as to be set within the range of a region indicated by dotted hatching in FIG. 2.

In a case where the refractory is manufactured under conventional firing conditions, when an Fe₂O₃ content in the refractory exceeds 1.2%, and the refractory is fired, an iron oxide component does not react with Al₂O₃ and SiO₂ and is not inactivated. Then, when heat treatment is performed with a heat treatment furnace using the refractory in which a large amount of iron oxide component is contained, the iron oxide component in the refractory is reduced, the iron component acts as a catalyst and thus carbon deposits in which carbon in an atmospheric gas is deposited in the refractory easily occur. Furthermore, when carbon deposits occur and thus the amount of carbon deposited and contained in the refractory is equal to or more than 0.05% by mass % and thus it is impossible to maintain the shape of the refractory serving as a constituent material of the furnace, with the result that the refractory collapses.

On the other hand, as the target firing temperature T is increased in a temperature range specified in Formula (2) described above, Fe₂O₃ which is the iron oxide component in the refractory after being fired further reacts with Al₂O₃ and SiO₂ to be inactivated. Furthermore, as the continuous firing time t during which after the temperature of the refractory is raised to the target firing temperature T, the longer the continuation of the firing of the refractory at the temperature, the higher the proportion the contribution to the inactivation of Fe₂O₃ by sufficiently reacting with Al₂O₃ and SiO₂. That is, as the firing parameter P calculated in Formula (4) described above is increased, Fe₂O₃ which is the iron oxide component in the refractory after being fired under such a condition can be made to react with Al₂O₃ and SiO₂ to be inactivated. Then, the firing parameter P is set larger in a predetermined relationship with the Fe₂O₃ amount, specifically, the firing conditions are set such that the firing parameter P and the Fe₂O₃ amount satisfy Formula (5) described above and thus it is possible to facilitate the inactivation of the iron oxide component in the refractory after being fired. In this way, when the heat treatment is performed in the heat treatment furnace using the refractory, the occurrence of carbon deposits is suppressed and thus the amount of carbon deposited in the refractory during the heat treatment can be less than 0.05%, with the result that it is possible to prevent the collapse of the refractory. Hence, the Fe₂O₃ amount, the target firing temperature T and the continuous firing time t are determined so as to satisfy Formulas (4) and (5), the firing is performed and thus it is possible to fire and generate the refractory in which the amount of carbon deposited in the refractory during the heat treatment is less than 0.05%.

In the firing condition determination step S101a, as described above, the Fe₂O₃ amount in the refractory, the target firing temperature T and the continuous firing time t are determined so as to satisfy all Formulas (1) to (5) described above. Here, for example, the Fe₂O₃ amount may be determined so as to satisfy Formula (1) described above, and then the target firing temperature T and the continuous firing time t may be determined so as to satisfy Formulas (2) to (5) described above. In this case, as the firing conditions for firing the refractory, the use of refractory raw materials that are less expensive in which an Fe₂O₃ content is high can be preferentially determined, and thus it is possible to more significantly reduce the manufacturing cost of the refractory.

In the firing condition determination step S101a, the Fe₂O₃ amount may be determined to be equal to or more than 2.0% and equal to or less than 2.2%, and then the target firing temperature T and the continuous firing time t may be determined so as to satisfy Formulas (2) to (5) described above. In this case, general refractory raw materials in which the reduction treatment of the Fe₂O₃ content is not performed can be used, and the reduction treatment of the Fe₂O₃ content is not needed at all, with the result that it is possible to more significantly reduce the manufacturing cost of the refractory.

In the firing condition determination step S101, the order in which the Fe₂O₃ amount, the target firing temperature T and the continuous firing time t are determined is not limited to the order described above, and they may be determined in an arbitrary order.

(Mixing-Kneading Step and Molding Step)

When the manufacturing conditions for the refractory are determined in the manufacturing condition determination step S101, several types of refractory raw materials which are selected so as to provide the Fe₂O₃ amount determined in the manufacturing condition determination step S101 are prepared. Then, in the mixing-kneading step S102, the prepared several types of refractory raw materials are mixed and kneaded. When the mixing and kneading of the refractory raw materials in the mixing-kneading step S102 are completed, then the molding step S103 is performed in which the refractory raw materials mixed and kneaded are molded into the refractory having a predetermined shape. In the molding step S103, for example, the refractory raw materials are charged into a mold which corresponds to the shape of a rectangular parallelepiped of a shaped refractory such as a firebrick, and thus the refractory raw materials are molded into the refractory having the shape corresponding to the mold. The molded refractory is taken out from the mold and is subjected to the firing in the temperature rise firing step S104 and the continuous firing step S105 which will be described later.

(Temperature Rise Firing Step)

In the molding step S103, powder obtained by mixing and kneading the several types of refractory raw materials is molded into the refractory having the shape corresponding to the shape of the shaped refractory, and thus the refractory is molded which contains the Fe₂O₃ amount of Fe₂O₃ determined in the manufacturing condition determination step S101. Then, when the molding step S103 is completed, the temperature rise firing step S104 is performed. In the temperature rise firing step S104, the molded refractory is arranged within the firing furnace, and is fired based on the firing conditions determined in the firing condition determination step S101a. That is, in the temperature rise firing step S104, a step is performed for using the refractory containing the Fe₂O₃ amount of Fe₂O₃ determined in the firing condition determination step S101a and firing the refractory within the firing furnace while raising the temperature of the refractory to the target firing temperature T.

(Continuous Firing Step)

When in the temperature rise firing step S104, the refractory is fired to have the target firing temperature T, then the continuous firing step S105 is performed. In the continuous firing step S105, the refractory which is fired while the temperature of the refractory is being raised in the temperature rise firing step S104 is fired within the firing furnace based on the firing conditions determined in the firing condition determination step S101a. That is, in the continuous firing step S105, a step is performed of firing the refractory whose temperature is raised to the target firing temperature T at the target firing temperature T for the continuous firing time t.

When the firing at the target firing temperature T for the continuous firing time t is completed, the continuous firing step S105 is completed, the firing of the refractory is completed and the refractory after being fired is generated. When the continuous firing step S105 is completed and the refractory is generated, the refractory is taken out from the firing furnace, and the manufacturing of the refractory is completed. At the time when the continuous firing step S105 is completed and the refractory is generated, the temperature of the refractory is high. Hence, after the completion of the continuous firing step S105, for example, by air cooling, etc., the refractory is cooled as necessary.

### Effects of Present Embodiment

In the refractory manufacturing method of the present embodiment, even when refractory raw materials that are inexpensive are used which could not be conventionally used, in which an Fe₂O₃ content is high, it is possible to manufacture the refractory for which it is possible to suppress the occurrence of carbon deposits in the use of the refractory as the heat treatment furnace refractory. Then, in the refractory manufactured by the refractory manufacturing method of the present embodiment, the amount of carbon deposited in the refractory during the heat treatment in the use of the refractory as the heat treatment furnace refractory can be less than 0.05%, with the result that it is possible to prevent the collapse of the refractory. In the refractory manufacturing method of the present embodiment, refractory raw materials that are inexpensive can be used in which an Fe₂O₃ content is high, and thus it is possible to significantly reduce the manufacturing cost. Furthermore, in the refractory manufacturing method of the present embodiment, even when the refractory raw materials that are inexpensive are used in which an Fe₂O₃ content is high, it is possible to manufacture the refractory for which it is possible to suppress the occurrence of carbon deposits, with the result that it is not necessary to perform the coating treatment on the surface of the refractory. Hence, refractory raw materials that are inexpensive can be used in which an Fe₂O₃ content is high, and a treatment material and a treatment step for the coating treatment on the surface of the refractory are not needed, with the result that it is possible to significantly reduce the cost.

Hence, in the present embodiment, it is possible to provide the method of manufacturing the refractory which is capable of manufacturing a refractory for which refractory raw materials that are inexpensive can be used in which an Fe₂O₃ content is high, for which it is not necessary to perform the coating treatment on the surface of the refractory and for which the occurrence of carbon deposits in the use of the refractory as the heat treatment furnace refractory can be suppressed.

In the present embodiment, in the firing condition determination step S101a, the Fe₂O₃ amount can be determined so as to satisfy Formula (1) described above, and then the target firing temperature T and the continuous firing time t can be determined so as to satisfy Formulas (2) to (5) described above. By the method described above, in the firing condition determination step S101a, the Fe₂O₃ amount is first determined, and the target firing temperature T and the continuous firing time t are determined according to the determined Fe₂O₃ amount. Hence, as the firing conditions for firing the refractory, the use of refractory raw materials that are less expensive in which an Fe₂O₃ content is high can be preferentially determined, and thus it is possible to more significantly reduce the manufacturing cost of the refractory.

In the present embodiment, the Fe₂O₃ amount can be determined to be equal to or more than 2.0% and equal to or less than 2.2% in the firing condition determination step S101a, and then the target firing temperature T and the continuous firing time t can be determined so as to satisfy Formulas (2) to (5) described above. By the method described above, general refractory raw materials in which the reduction treatment of the Fe₂O₃ content is not performed can be used, and the reduction treatment of the Fe₂O₃ content is not needed at all, with the result that it is possible to more significantly reduce the manufacturing cost of the refractory.

Although an embodiment of the present invention is described above, the present invention is not limited to the embodiment described above, and can be variously changed within the scope of the claims. That is, the present invention is not limited to the embodiment described above, and is intended so that modifications and applications related to those included in the claims and to be clarified by reading and understanding this description, and equivalents, are all included in the scope of the present invention.

### Example

A test for clarifying a relationship between firing conditions in manufacturing refractories and the occurrence of collapse of the refractories when the refractories manufactured under the firing conditions were used in a heat treatment furnace to demonstrate the effects of the present embodiment was performed. Specifically, a refractory heat treatment test was performed in which the refractories were fired under various firing conditions to be manufactured as samples, in which the manufactured refractories were subjected to heat treatment in the heat treatment furnace and in which the collapse of the refractories was investigated. In the refractory heat treatment test, the heat treatment of the refractories was performed by performing a simulation under conditions obtained by accelerating treatment conditions in the heat treatment furnace configured as a carburizing and quenching furnace, and thus the occurrence of collapse of the refractories was investigated.

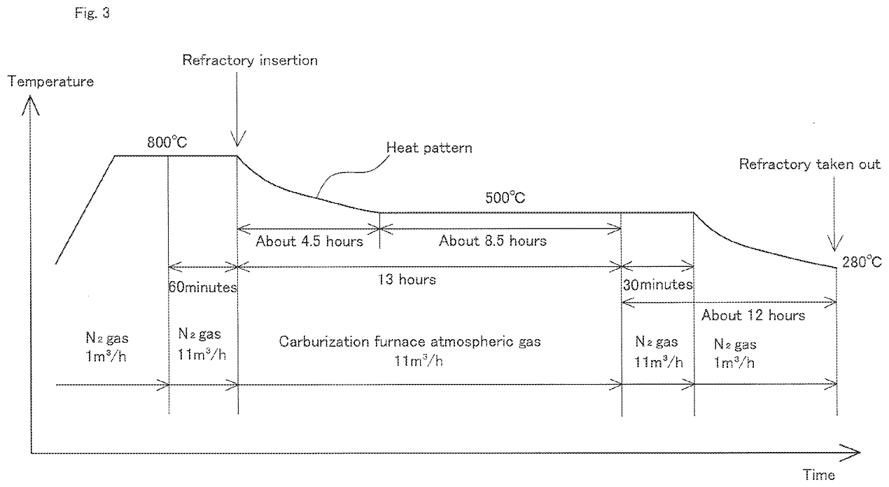

FIG. 3 is a diagram for illustrating a method of the refractory heat treatment test in which the occurrence of collapse of the refractories was investigated by performing the simulation under the conditions obtained by accelerating the treatment conditions in the heat treatment furnace. FIG. 3 shows a heat pattern when the heat treatment was performed on the refractories within the heat treatment furnace in the refractory heat treatment test. In the refractory heat treatment test shown in FIG. 3, the temperature of an atmospheric gas within the furnace was first raised to 800° C. while N₂ gas serving as an inert gas was being supplied into the heat treatment furnace at a flow rate of 1 m³/h, thereafter the temperature of the atmospheric gas within the furnace was maintained at 800° C. for 60 minutes while the N₂ gas was being supplied at a flow rate of 11 m³/h and thus the heat was uniformized. Then, in such a state, the refractories of the samples manufactured by being fired under various types of firing conditions were inserted into the heat treatment furnace. After the insertion of the refractories into the heat treatment furnace, an atmospheric gas which was obtained by simulating the conditions of the atmospheric gas of the carburizing furnace and which contained carbon monoxide was supplied into the heat treatment furnace. Here, after the insertion of the refractories into the heat treatment furnace, the temperature of the atmospheric gas within the furnace was lowered from 800° C. to 500° C. for about 4.5 hours, and then the temperature of the atmospheric gas within the furnace was maintained at 500° C. for about 8.5 hours. Thereafter, while the N₂ gas was being supplied into the heat treatment furnace, the temperature of the atmospheric gas within the furnace was lowered from 500° C. to 280° C. for about 12 hours. Here, for the first 30 minutes, the temperature of the atmospheric gas within the furnace was maintained at 500° C. while the N₂ gas was being supplied into the heat treatment furnace at a flow rate of 11 m³/h, and then the temperature of the atmospheric gas within the furnace was gradually lowered to 280° C. while the N₂ gas was being supplied into the heat treatment furnace at a flow rate of 1 m³/h. Then, in a state where the temperature of the atmospheric gas within the furnace was lowered to 280° C., the refractories were taken out from the heat treatment furnace.

As the refractory heat treatment test, first, the test for clarifying the relationship between the firing conditions of the refractories and the occurrence of collapse of the refractories when the refractories manufactured under the firing conditions were used in the heat treatment furnace was performed. In this test, first, with respect to the Fe₂O₃ amount, the target firing temperature T and the continuous firing time t which were the firing conditions of the refractories, the conditions (the target firing temperature T and the continuous firing time t) other than the Fe₂O₃ amount were set to the same conditions as in a conventional method of manufacturing a heat treatment furnace refractory, the Fe₂O₃ amount was variously changed, the refractories were fired and the refractories serving as the samples were manufactured. Specifically, the target firing temperature T was set to 1300° C. which was a firing temperature in the conventional method of manufacturing the heat treatment furnace refractory, the continuous firing time t was set to 4 hrs which was a continuous firing time in the conventional method of manufacturing the heat treatment furnace refractory, the Fe₂O₃ amount was variously changed, the refractories were fired and the refractories were manufactured. By the method of the refractory heat treatment test shown in FIG. 3, the heat treatment was performed on the refractories serving as the samples which were manufactured, and thus the test for clarifying the relationship with the occurrence of collapse of the refractories was performed.

Table 1 is a table which shows the components of the samples used in the test for clarifying the relationship between the firing conditions and the occurrence of collapse of the refractories and the test results. As shown in Table 1, the refractories in which an Fe₂O₃ content, a SiO₂ content, an Al₂O₃ content and a TiO₂ content by mass % were contents indicated in sample numbers 1 to 9 of Table 1 were fired, and the nine types of refractories after being fired serving as the samples were manufactured. The value in the section of Fe₂O₃ [mass %] in Table 1 indicates the Fe₂O₃ amount serving as the firing condition.

TABLE 1

| Sample | | | | | | | | | |
|---|---|---|---|---|---|---|---|---|---|
| Number | 1 | 2 | 3 | 4 | 5 | 6 | 7 | 8 | 9 |
| Fe₂O₃ | 0.74 | 0.8 | 0.91 | 1.07 | 1.09 | 1.18 | 1.33 | 1.62 | 1.78 |
| [Mass %] | | | | | | | | | |
| SiO₂ | 41.14 | 43.07 | 43.31 | 50.36 | 50.89 | 52.60 | 33.09 | 24.02 | 47.78 |
| [Mass %] | | | | | | | | | |
| Al₂O₃ | 55.97 | 52.15 | 53.60 | 45.86 | 44.86 | 43.21 | 62.02 | 70.50 | 47.02 |
| [Mass %] | | | | | | | | | |
| TiO₂ | 1.23 | 1.41 | 1.32 | 1.95 | 2.08 | 1.96 | 2.37 | 2.66 | 1.38 |
| [Mass %] | | | | | | | | | |
| Deposited | 0.04 | 0.02 | 0.04 | 0.04 | 0.03 | 0.02 | 0.06 | 0.09 | 2.27 |
| Carbon | | | | | | | | | |
| Amount | | | | | | | | | |
| [Mass %] | | | | | | | | | |
| Breakage | 0 | 0 | 0 | 0 | 0 | 0 | 100 | 100 | 100 |
| Rate [%] | | | | | | | | | |

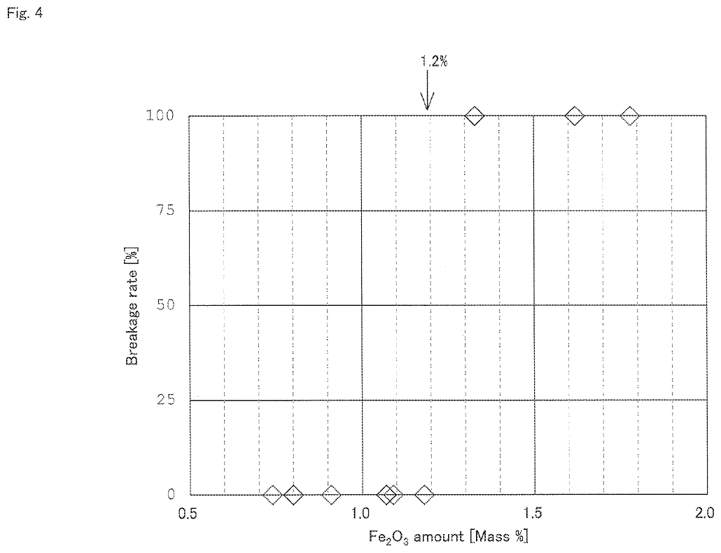

In the test for clarifying the relationship between the firing conditions and the occurrence of collapse of the refractories, the heat treatment in the refractory heat treatment test shown in FIG. 3 was individually performed for the nine types of refractories manufactured and indicated in sample numbers 1 to 9 of Table 1, and the occurrence status of collapse of the refractories was checked. The occurrence status of collapse of the refractories was evaluated by a breakage rate (%) which was a ratio of the volume of a broken part caused by the collapse of the refractory after the heat treatment to the overall volume. The breakage rate of the refractory of the sample which did not collapse at all and has no broken part was evaluated to be 0%, and the breakage rate of the refractory of the sample which collapsed as a whole to become powdery was evaluated to be 100%. That is, when the breakage rate was 0%, the refractory did not collapse at all whereas when the breakage rate was 100%, the refractory completely collapsed such that all the refractory became powdery. In Table 1, as the test results, the breakage rates for the nine types of refractories indicated in sample numbers 1 to 9 are also individually shown. FIG. 4 is a graph showing a relationship between the Fe₂O₃ amounts in the refractories and the breakage rates of the refractories after the refractory heat treatment test. The Fe₂O₃ amounts and the breakage rates in the test results shown in Table 1 are the same as the details of the graph of FIG. 4.

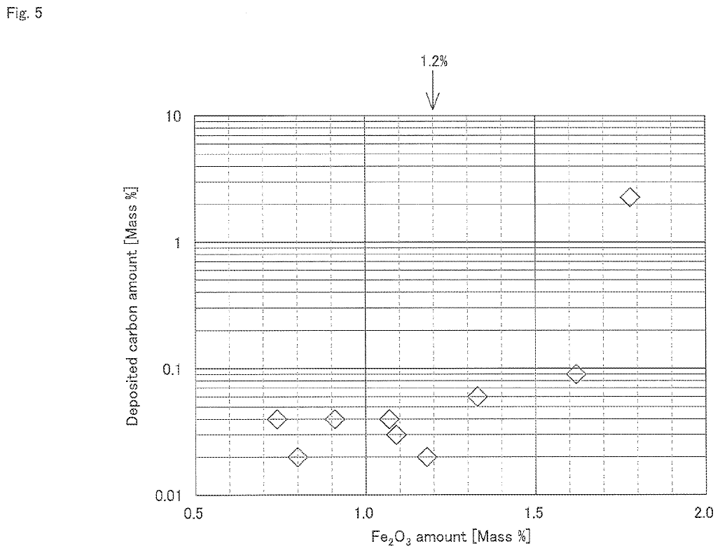

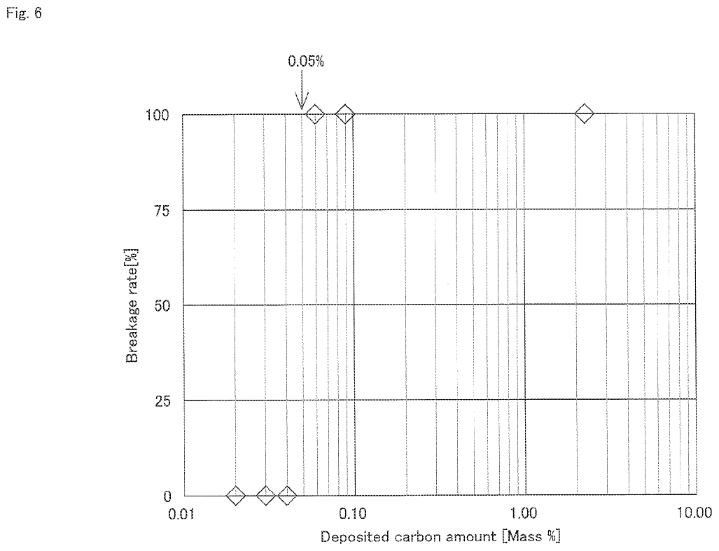

In the test for clarifying the relationship between the firing conditions and the occurrence of collapse of the refractories, a deposited carbon amount (mass %) which was the amount of carbon deposited and contained in the refractory as a result of the occurrence of carbon deposits at the time of the heat treatment was measured for the nine types of refractories in which the heat treatment in the refractory heat treatment test shown in FIG. 3 was performed and which were indicated in sample numbers 1 to 9 of Table 1. The measurement of the deposited carbon amount was performed by using a method of quantifying free carbon in a combustion method defined in “JIS (Japanese Industrial Standards) R2011.” In Table 1, as the test results, the deposited carbon amounts of the nine types of refractories indicated in sample numbers 1 to 9 are also individually shown. FIG. 5 is a graph showing a relationship between the Fe₂O₃ amounts in the refractories and the deposited carbon amounts of the refractories after the refractory heat treatment test. FIG. 6 is a graph showing a relationship between the deposited carbon amounts and the breakage rates of the refractories after the refractory heat treatment test. The Fe₂O₃ amounts and the deposited carbon amounts in the test results shown in Table 1 are the same as the details of the graph of FIG. 5, and the deposited carbon amounts and the breakage rates in the test results shown in Table 1 are the same as the details of the graph of FIG. 6.

As is clear from Table 1 and FIGS. 4 to 6, it has been found that in a case where the conditions (the target firing temperature T and the continuous firing time t) other than the Fe₂O₃ amount are the same conditions as in the conventional method of manufacturing the heat treatment furnace refractory, when the Fe₂O₃ amount is equal to or less than 1.2%, the deposited carbon amount caused by the occurrence of carbon deposits is less than 0.05% and thus the collapse of the refractory does not occur. On the other hand, it has been found that when the Fe₂O₃ amount exceeds 1.2%, the deposited carbon amount caused by the occurrence of carbon deposits is equal to or more than 0.05% such that the collapse of the refractory occurs. Hence, it has been demonstrated that it becomes possible to use refractory raw materials that are inexpensive which could not be conventionally used, in which an Fe₂O₃ content is high due to the fact that it is possible to suppress the occurrence of carbon deposits in the heat treatment furnace using the refractory manufactured with the refractory raw materials in which an Fe₂O₃ content is equal to or more than 1.2%.

With consideration given to the results of the demonstration described above, a test for clarifying firing conditions where even when a refractory was used in which the Fe₂O₃ amount exceeded 1.2%, it was possible to fire and generate the refractory in which the occurrence of carbon deposits during the heat treatment was suppressed and in which the deposited carbon amount was less than 0.05% and for demonstrating the effects of the present embodiment was performed. In this test, the firing conditions of the target firing temperature T and the continuous firing time t were first set such that the firing parameter P determined in Formula (4) described above was variously changed, and thus various levels of the firing parameters P were set. Then, for the various levels of the set firing parameters P, firing conditions were individually set so as to variously change the Fe₂O₃ amount. Specifically, as the levels of the firing parameters P, eleven levels were set as shown in Table 2. That is, the target firing temperature T was changed to 1300° C., 1350° C., 1400° C. or 1450° C., the continuous firing time t was changed to 4 hrs, 6 hrs or 8 hrs for the individual target firing temperatures T and these target firing temperatures T and the continuous firing times t were combined together, with the result that the total of eleven levels of the firing parameters P were set. Then, for the various levels of the firing parameters P, the firing conditions were individually set to variously change the Fe₂O₃ amount.

Refractories were fired under the firing conditions which were individually set as described above, and thus the refractories after being fired were manufactured as samples. Then, by the method of the refractory heat treatment test shown in FIG. 3, the heat treatment was performed on the refractories serving as the samples which were manufactured, and a test for checking the occurrence status of collapse of the refractories manufactured under the individual conditions of the Fe₂O₃ amounts which were variously changed and set for the individual levels of the firing parameters P was performed. In this way, for each of the levels of the firing parameters P, a region of the Fe₂O₃ amount where the collapse of the refractory did not occur and a region of the Fe₂O₃ amount where the collapse of the refractory occurs were checked, and a limit Fe₂O₃ amount which was the limit of the Fe₂O₃ amount capable of preventing the collapse of the refractory was confirmed.

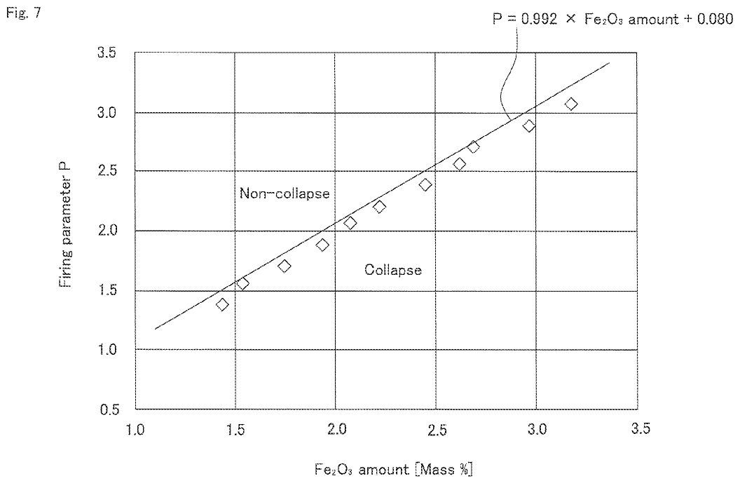

Table 2 is a table which shows the results of the test described above and a relationship between the firing parameters P and the limits of the Fe₂O₃ amounts (limit Fe₂O₃ amounts) capable of preventing the collapse of the refractories. FIG. 7 is a graph showing a relationship between the firing parameters P and the limit Fe₂O₃ amounts. The firing parameters P and the limit Fe₂O₃ amounts in the test results shown in Table 1 are the same as the data plotted on the graph of FIG. 7.

TABLE 2

| Target Firing | Continuous | Firing | Limit Fe₂O₃ | Deposited |
|---|---|---|---|---|
| Temperature | Firing Time | Parameter | Amount | Carbon Amount |
| T [° C.] | t [h] | P | [Mass %] | [Mass %] |
| 1300 | 6 | 1.378 | 1.44 | 0.04 |
| 1300 | 8 | 1.560 | 1.54 | 0.04 |
| 1350 | 4 | 1.700 | 1.75 | 0.04 |
| 1350 | 6 | 1.883 | 1.94 | 0.04 |
| 1350 | 8 | 2.065 | 2.08 | 0.04 |
| 1400 | 4 | 2.205 | 2.22 | 0.04 |
| 1400 | 6 | 2.388 | 2.45 | 0.04 |
| 1400 | 8 | 2.570 | 2.62 | 0.04 |
| 1450 | 4 | 2.710 | 2.69 | 0.04 |
| 1450 | 6 | 2.893 | 2.97 | 0.04 |
| 1450 | 8 | 3.075 | 3.18 | 0.04 |

With reference to Table 2 and FIG. 7, for example, when the firing parameter P was the level of 1.378 (the level at which the target firing temperature T was 1300° C. and the continuous firing time t was 6 hrs), under the firing conditions in which the Fe₂O₃ amount was equal to or less than 1.44%, the collapse of the refractory did not occur whereas under the conditions in which the Fe₂O₃ amount exceeded 1.44%, the collapse of the refractory occurred. Hence, when the firing parameter P was the level of 1.378, the limit Fe₂O₃ amount was confirmed to be 1.44%. For example, when the firing parameter P was the level of 2.205 (the level at which the target firing temperature T was 1400° C. and the continuous firing time t was 4 hrs), under the firing conditions in which the Fe₂O₃ amount was equal to or less than 2.22%, the collapse of the refractory did not occur whereas under the conditions in which the Fe₂O₃ amount exceeded 2.22%, the collapse of the refractory occurred. Hence, when the firing parameter P was the level of 2.205, the limit Fe₂O₃ amount was confirmed to be 2.22%. Likewise, for all the levels of the firing parameters P at which the test was performed, the limit Fe₂O₃ amounts were confirmed, and thus the test results shown in Table 2 and FIG. 7 were obtained. In FIG. 7, since in a region where the Fe₂O₃ amounts were equal to or less than the limit Fe₂O₃ amount at the levels of individual firing parameters P, the collapse did not occur in all the refractories, “Non-collapse” is displayed in the region. On the other hand, since in a region where the Fe₂O₃ amounts exceeded the limit Fe₂O₃ amount at the levels of individual firing parameters P, the collapse occurred in all the refractories, “Collapse” is displayed in the region.

In the test described above, the deposited carbon amount was measured for the refractories in which the Fe₂O₃ amounts were the limit Fe₂O₃ amount at the levels of individual firing parameters P. Consequently, it has been confirmed that as shown in Table 2, the deposited carbon amount was 0.04% and less than 0.05% in all the refractories in which the Fe₂O₃ amounts were the limit Fe₂O₃ amount.

Formulas (4) and (5) described above used in the firing condition determination step S101a in the refractory manufacturing method of the present embodiment are specified based on the test results described above. Formula (4) described above is specified as a computation formula in which the firing parameter P is determined which is identified by a relationship between the target firing temperature T and the continuous firing time t by performing a multiple regression analysis using a least squares method with the assumption that the target firing temperature T and the continuous firing time t are variables on the limit Fe₂O₃ amount.

In order to set the firing conditions in which the occurrence of carbon deposits is suppressed and in which thus it is possible to prevent the collapse of the refractory, a relationship between the firing parameter P calculated in Formula (4) described above and the Fe₂O₃ amount serving as the firing condition needs to be set so as to be identified in the region where the “Non-collapse” is displayed in the test results shown in FIG. 7. That is, for the individual firing parameters P, the relationship between the firing parameters P and the Fe₂O₃ amounts needs to be set such that the Fe₂O₃ amounts serving as the firing conditions are less than the limit Fe₂O₃ amount. Hence, when based on the test results shown in FIG. 7, for the individual firing parameters P, a relational formula for the firing parameters P and the Fe₂O₃ amounts is determined as a border in which the Fe₂O₃ amounts serving as the firing conditions are less than the limit Fe₂O₃ amount, Formula (6) described below is determined.

P=0.992×Fe₂O₃ amount+0.080 Formula (6)

Hence, the firing parameter P and the Fe₂O₃ amount are set so as to satisfy Formula (5) described above, and thus it is possible to set the firing conditions in which the occurrence of carbon deposits is suppressed and in which thus it is possible to prevent the collapse of the refractory.

In the refractory manufacturing method of the present embodiment, the firing conditions of the Fe₂O₃ amount in the refractory, the target firing temperature T and the continuous firing time t are determined so as to satisfy all Formulas (1) to (5) described above. Hence, it is possible to use refractory raw materials that are inexpensive which could not be conventionally used, in which an Fe₂O₃ content is high, and thus it is not necessary to perform the coating treatment on the surface of the refractory. As is clear from the test results shown in Table 2 and FIG. 7, with the refractory fired and manufactured under the firing conditions which satisfy all Formulas (1) to (5) described above, the occurrence of carbon deposits in the use of the refractory as the heat treatment furnace refractory is suppressed, with the result that it is possible to prevent the collapse of the refractory. Hence, it has been demonstrated from the test results described above that in the refractory manufacturing method of the present embodiment, it is possible to manufacture the refractory for which refractory raw materials that are inexpensive can be used in which an Fe₂O₃ content is high, for which it is not necessary to perform the coating treatment on the surface of the refractory and for which the occurrence of carbon deposits in the use of the refractory as the heat treatment furnace refractory can be suppressed.

### INDUSTRIAL APPLICABILITY

The present invention can be widely applied as a method of manufacturing an Al₂O₃—SiO₂-based refractory in which an Al₂O₃ content is equal to or more than 35% and equal to or less than 80% by mass %.

What is claimed is:

1. A method of manufacturing an Al₂O₃—SiO₂-based refractory in which an Al₂O₃ content is equal to or more than 35% and equal to or less than 80% by mass %, the method comprising:
a firing condition determination step of determining, as firing conditions for firing the Al₂O₃—SiO₂-based refractory, an Fe₂O₃ amount (mass %) which is an Fe₂O₃ content in the refractory, a target firing temperature T (° C.) serving as a target temperature to which a temperature of the refractory is raised when the refractory is fired and a continuous firing time t (hr) serving as a time during which the firing of the refractory is continued at the target firing temperature T after the temperature of the refractory is raised to the target firing temperature T;
a temperature rise firing step of using the refractory which contains the Fe₂O₃ amount of Fe₂O₃ determined in the firing condition determination step and firing the refractory while raising the temperature of the refractory to the target firing temperature T; and
a continuous firing step of firing the refractory whose temperature is raised to the target firing temperature T at the target firing temperature T for the continuous firing time t,
wherein in the firing condition determination step, the Fe₂O₃ amount, the target firing temperature T and the continuous firing time t are determined so as to satisfy all Formulas (1) to (5) described below.
1.2<Fe₂O₃ amount≤2.5 Formula (1)
1250≤T≤1450 Formula (2)
0≤t Formula (3)
P=0.0101×T+0.0913×t−12.3 Formula (4)
P>0.992×Fe₂O₃ amount+0.080 Formula (5)

2. The method of manufacturing the refractory according to claim 1,
wherein in the firing condition determination step, the Fe₂O₃ amount is determined so as to satisfy the Formula (1), and then the target firing temperature T and the continuous firing time t are determined so as to satisfy the Formulas (2) to (5).

3. The method of manufacturing the refractory according to claim 2,
wherein in the firing condition determination step, the Fe₂O₃ amount is determined to be equal to or more than 2.0% and equal to or less than 2.2%, and then the target firing temperature T and the continuous firing time t are determined so as to satisfy the Formulas (2) to (5).
